(19) United States
(12) Patent Application Publication
(10) Pub. No.: US 2015/0081363 A1
(43) Pub. Date: Mar. 19, 2015

(54) Group-Oriented Software Development

(71) Applicant: TechCrowd Services, Inc., Pullman, WA (US)

(72) Inventors: Joseph D. Taylor, Pullman, WA (US); Albert H. Carlson, Moscow, ID (US); Joseph B. Harris, Pullman, WA (US)

(21) Appl. No.: 14/299,998

(22) Filed: Jun. 9, 2014

Related U.S. Application Data
(60) Provisional application No. 61/832,710, filed on Jun. 7, 2013.

(51) Int. Cl. G06F 9/44; G06Q 40/00; G06Q 10/06

(52) U.S. Cl. CPC G06F 8/70; G06Q 10/063112; G06Q 40/00
USPC 705/7.14; 717/102

(57) ABSTRACT

A group-oriented software development technology is described. A software development project with a set of project parameters may be defined. The software development project may be divided into a set of work packages based in part on a desired skill level associated with the work packages. A bidding process may be initiated involving a plurality of software developers, to enable a software developer having the desired skill level for a work package to place a bid to work on the work package. Each of the work packages may be assigned to the software developers upon completion of the bidding process. Implemented packages and documentation may be received for each of the work packages from the software developers. The work packages may be integrated into the software development project upon automatically testing a functionality of the work packages. The software development project that is completed according to the set of project parameters may be provided to a customer.

### RELATED APPLICATIONS

The present application claims priority to U.S. Provisional Patent Application No. 61/832,710, filed Jun. 7, 2013, the entire specification of which is hereby incorporated by reference in its entirety for all purposes.

### BACKGROUND

Software development includes several stake holders that are involved in some capacity from conception through to implementation of the software. In planning and structuring the software development process, software development methods have been developed with the hope of increasing efficiency, reliability, or general value added through the software development process.

For example, the waterfall software development method is a sequential design process, in which progress is seen as flowing steadily downwards, and in this sense resembles a waterfall-like structure. In the waterfall method, a detailed plan is generally created with interdependencies, risks and requirements clearly documented and understood by all stakeholders. In the waterfall method, the creation of the information technology (IT) deliverable follows a series of defined, sequential steps. In general, the waterfall method proceeds by: collecting requirements, designing the output, constructing the output, and testing and implementing the project.

Methods in the manufacturing and construction industries may have impacted the creation of the waterfall method for software development. Methods within the manufacturing and construction industries, for example, may generally be fashioned to create a highly structured physical environment in which late changes are prohibitively costly or impossible. Software and other related technology projects, however, may often have limited information at the beginning of the project, and frequently expand or change as additional requirements are discovered or understood during the course of the project.

### BRIEF DESCRIPTION OF THE DRAWINGS

FIG. 1 is a flowchart illustrating a project flow according to an example of the present technology.

FIG. 2 is an illustration of a networked system for group-oriented software development according to an example of the present technology.

FIG. 3 is a flowchart illustrating a project work flow according to an example of the present technology.

FIG. 4 is a flowchart illustrating an additional project work flow according to an example of the present technology.

FIG. 5 is a flowchart illustrating a project work flow using marketing research and engineering analysis according to an example of the present technology.

FIG. 6 is a flowchart illustrating a reverse bidding auction according to an example of the present technology.

FIG. 7 is a flowchart of an example method for group-oriented software development.

FIG. 8 is a flowchart of an example method for group-oriented software development.

FIG. 9 is block diagram illustrating an example of a computing device that may be used in group-oriented software development.

### DETAILED DESCRIPTION

In pursing the development of tangible, relatively well understood, physical assets such as buildings or highways, generally the waterfall development method may be an effective means of organizing and planning the resource loads used to develop a project. The definitions of the project are clearly understood, and easily interpreted by stakeholders who may not generally be construction professionals. Once a project has begun, a relatively limited amount of end user oversight is generally used to insure that the delivery of the project continues to meet the business needs.

In contrast with traditional construction projects, technology projects, such as software development, may often be poorly understood at the outset, and some of the parameters used to deliver the project may only be understood by project team members with specific technical knowledge. As the iterative process of software development proceeds, additional specifications are frequently identified. Some of the additional specifications may be functional, meaning that the final software output may have defined specific business functionality, while other requirements identified may be nonfunctional, meaning that the specification refers to expectations of response time, bandwidth constraints or other technical needs of the system unrelated to business capabilities. Often end users may be unfamiliar with the full extent of the business requirements of an IT (information technology) project at the outset, and may be unfamiliar with the possible business implications of the nonfunctional requirements in eventual system usability. Requirements may frequently continue to filter out of the user base throughout the construction process.

Another challenge to using the waterfall method in technology development may be that the project's value may be provided at the end of the project at a delivery phase. In this way, there are limited opportunities for delivery of partial functionality built into the waterfall method and business users may wait the duration of the project before having the opportunity to provide feedback on the output.

Despite the seeming mismatch of the waterfall method with the realities of software development, the waterfall method is fairly prevalent in information technology (IT) project management. The waterfall method may easily be understood by business managers unfamiliar with IT, and the well-defined nature of the outputs may facilitate waterfall based planning to conform to most corporate budgeting procedures.

In response to the rigidity of the traditional waterfall method of project delivery, some advanced IT teams have increasingly adopted a more iterative approach to project management, requirements gathering and software delivery. In contrast to the waterfall method—where a project attempts to aggregate a holistic, potentially multiyear collection of requirements—short intervals may be planned that provide limited, self-contained functionality to the users. As one interval is completed, with specific functionality delivered, the next interval is planned and the process begins again. The requirements gathering, design and construction steps described in the waterfall method still take place, but these steps may take place in a shorter, more iterative manner. This shorter, more iterative manner allows a team to rapidly adjust as greater clarity to the requirements is achieved through iterative, relatively quick feedback. Moreover, the outcome of the intervals may give users tangible results to the requirements or specifications that the users have provided, and facilitates more rapid identification of functional and nonfunctional requirements to be included in the next development iteration. This iterative nature may also allow development resources to participate in some, but not all of the specific intervals (called “sprints”).

A sprint is an accelerated work cycle. Generally, working within the boundaries of the accelerated work cycle, a team creates a working product. For example, the team may be able to build the most essential functionality within a sprint as the project progresses. Developers need not be assigned to the same projects for months, or at times years, in completing a job. Specialized skills may be assembled and coordinated for each sprint as needed by the project managers or architects. The methodology allows for clear milestones that allow the project to reconfigure resource assignments to meet the needs of each sprint.

The iterative process of delivering partial product through the sprint intervals is more effective using a close working relationship between a group of user representatives and developers engaged in the project. There are fewer clearly defined hand-off areas between stakeholders, as there may be broader joint ownership of the work between the technical and business resources.

This iterative software development method may represent a more flexible delivery management approach than might be achieved through the waterfall method, but there also may be challenges in effectively utilizing this iterative software development method. In particular, some of the main challenges include: financial management, user community engagement and scope creep.

Software is generally developed as a result of an identified need. This identified need drives the functionality that needs to be developed or, in other words, the scope of the software development project. Project plans, including cost and time estimates are based on the scope of the software development project. Sometimes during the course of the software development project, a customer generates additional requirements. For example, the customer may have forgotten to mention the additional requirements or was unaware that he needed the additional requirements. These additional requirements are termed scope creep, and adding these additional requirements may often cause the software development project to take longer than anticipated or increase project costs. The technology introduces a way to make outsourcing more practical in agile development environments.

Financial management may be a challenge in employing iterative software development methods. For example, there often times may not be a clear understanding of the costs and potential benefits of the project prior to commencing work. In order to provide some financial guidance to projects, companies may choose to provide the project a budget and a loose list of requirements that must be delivered within the assigned budgetary amount. This approach may allow a firm to provide a broad based set of guidelines and expectations to the project team, while still allowing for creativity and inter-project prioritization during each of the project's iterative intervals.

The iterative software development method may not necessarily consume more ongoing participation from the business users during the development process. However, for business users that are accustomed to simply passing requirements to the IT team and passively waiting for the project output to be completed, the degree of user participation in the development process of iterative methods may seem excessive as compared to their previous development process. The iterative approach in the software development method may in fact generate some throw-away work, as the ideas behind the project are iteratively or successively refined. While this iterative involvement may take more effort on the part of business users during the development process, the iterative involvement may also decrease the potential for the business users to experience unfortunate surprises at the end of the project. For example, a business user may be able to recognize deviation from the intended product results and provide more timely feedback when he finds out that a deliverable software component does not meet his needs.

Many software project clients may not have the ability to retain highly skilled employees for infrequent software development projects. Further, the more rare a given software development skill, the higher the overhead used to keep a staff member with the given software development skill on staff. Moreover, oftentimes a given software development skill may be infrequently applied. However, when such a skill is desired, the need for the skill may be invaluable. Instead of a company needing to retain employees with such specialized skills, technology can provide access to these skills to many companies on demand.

In one example, integrated services from multiple freelance workers may be provided under the control of centralized project and account management from the supplying company. Unlike traditional freelancing arrangements, the supplier clients may not manage freelancers at an individual level. With the technology a software project client may be able to hire multiple coordinated freelancers under one work contract. Further, freelance developers may be able to work with other freelancers for multiple software project clients under one contract. This ability for software project clients and freelance developers to work under one contract may greatly simplify overhead time and expense in creating software project relationships.

The service supplier may employ architects to decompose large projects into skill set specific work packages. Each work package designed by the service suppliers' architects may include integration requirements, relevant test scripts, relevant coding standards, estimated skill levels to complete, estimated required time to complete and a due date. The work packages may also be known as software modules. Work packages may be designed to segment tasks with higher skill level requirements (e.g. Database design) from tasks that are more repetitive in nature (e.g. writing data extraction, transformation and loading protocols). This approach may eliminate the need for individual freelancers to evaluate the fit of a work package to their personal skills, allow multiple freelance workers to participate together on a project without identifying their own collaborators and allow for freelance work participation by workers at a variety of skill levels (e.g. entry level technical skills or advance design skills.)

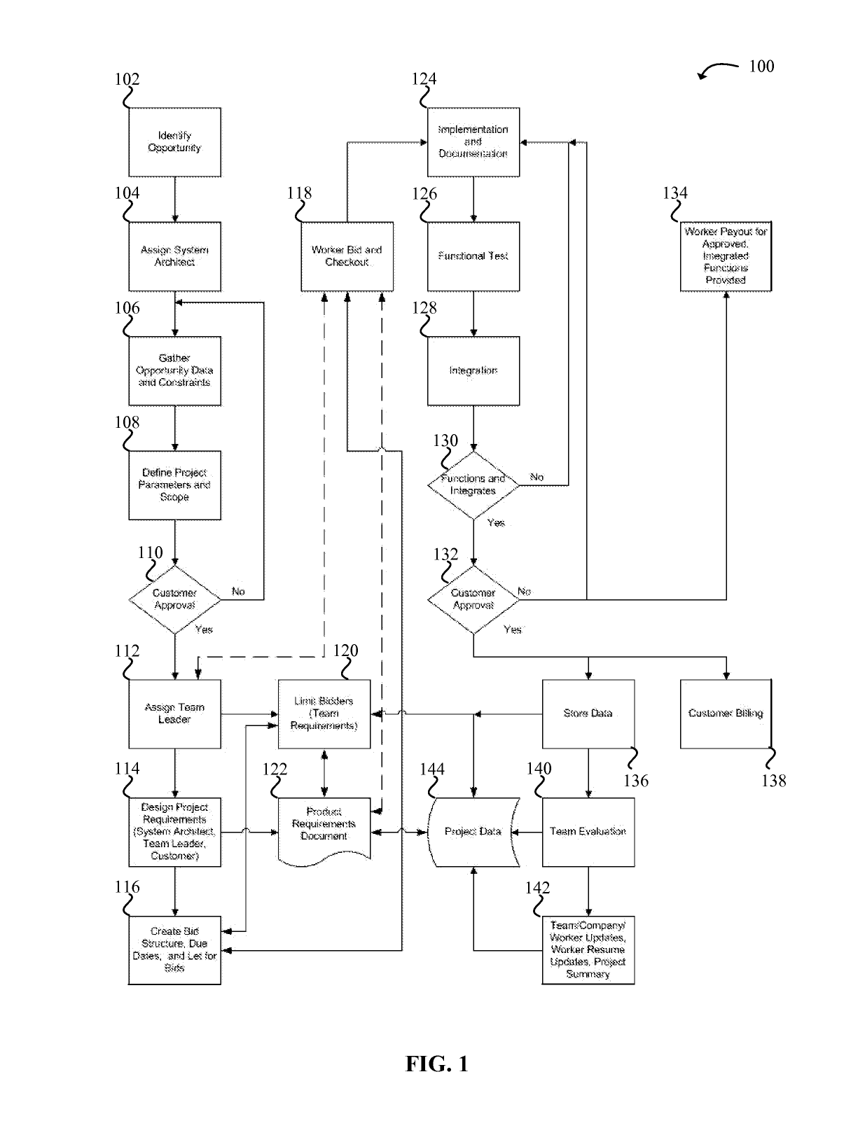

FIG. 1 is a flow chart illustrating an example project flow 100. The project flow 100 may begin with an identification of customer need 102. Services based on a defined customer need are provided, in contrast to some other an alternative IT service providers. The project flow 100 leverages the enterprise and application architecture of clients, and provides a consistent execution of standards and interfaces to allow for end product integration in a group-oriented software development environment.

Once the identification of customer need 102 has been performed, an architect may be assigned 104 to work with the client to identify the level of defined interfaces that exist between the newly requested project and the existing legacy technical environment. Based on this assessment, the architect can work with the client to evaluate the development opportunity 106, as well as identify and remediate any architectural gaps that may exist between the requested work and a legacy environment.

Using this assessment the architect can work with the client's representative to define the project parameters and scope 108. Based on the customer approval 110 of the high level approach and scope, a team leader can be assigned 112 and more detailed project requirements or specifications are collected.

Once a project has begun based on the design, the architect, in conjunction with the team leader and client representatives, can evaluate the number, complexity and level of effort for each of the identified work packages 114. Design project requirements and a product requirements document 122 may be generated by the architect and/or team leader. Each work package may have an accompanying estimate of the level of skills and the amount of time necessary to complete the work 116. A bid structure may be created with due dates and results in the project being let for bids. In addition to the skill and time estimates, each package can have defined functional, nonfunctional and integration requirements to be met prior to payment. Based on this assessment, a market-price may be estimated for each work package. These market prices are recommended by the architect, but can be approved by the client representative as part of the overall project budget.

At the request of the client, freelance developers (e.g., freelance software developers) may have the opportunity to place a bid on the completion of work in the defined work package. Multiple developers may bid on a work package, and the number of bids selected may be at the discretion of the architect through consultation with the client. Upon client approval of work package payments, the work packages may be made visible to freelance development resources listed within a freelancer database. In instances where the payment terms for the work package have been pre-determined, the freelance developers may claim work packages as defined in the freelancer database. In instances where the client is soliciting bids to complete the work, the defined work package may be made visible to qualified members of the freelance developer pool, who would submit their bid to complete the work. The winning freelancer bids may be selected by the architect with client confirmation.

Multiple freelance developers may participate in a single project, and a single developer may participate in multiple projects. Freelance developers may bid on a work package 118 for which they are technically qualified and, upon winning the bid, begin to work as part of the virtual team of resources committed to the project. Work packages may be limited to developers 120 of a minimum evaluation rating. Evaluation ratings may be a composite of experience, education, prior work evaluation, delivery history, peer review, client review, technical skill, problem solving ability, community contributions and peer recognition.

Upon completion of a work package, the freelance developer can submit the work to an integrated development environment as defined by the architect. The completed work package can include implemented computer code and related documentation 124, as well as citations of any code reused from a code store. The team leader may orchestrate an integrated testing 126 of the work packages that have been developed to insure both that the independent work package functions properly, as well as integrates into the functionality 128 correctly. If a work package does not function as specified, the package may be immediately returned to the freelance developer for correction. If the integrated software product does not function, deviant work packages are identified and the freelance developers engaged may work together to remediate whatever issues keep the integrated product from working.

Once integrated testing is complete 130, the final product can be provided to the client for approval 132. Based on client approval 132, the code may be released 136, and the client may be billed 138. If there is no client approval 132, the developers may still be paid 134 for their contribution of work packages that integrate and function properly. The robust and iterative nature of the development process may create a large number of data points 144 that can be used to measure developer, client, architect and/or team leader effectiveness 140. The relevant metrics can be collected, stored and analyzed 142.

The group-oriented software development methodology may be highly data driven, the transparency of metrics, and the individual accountability provided thereby, may generally be components of success. Within the group-oriented software development model, high levels of metric driven, quantitative performance management can reduce the need for expensive, non-valuing contributing middle management and thereby can reduce group-oriented software development overhead. This lower overhead may be reinvested in competitive pricing to clients, and competitive payment to freelancers.

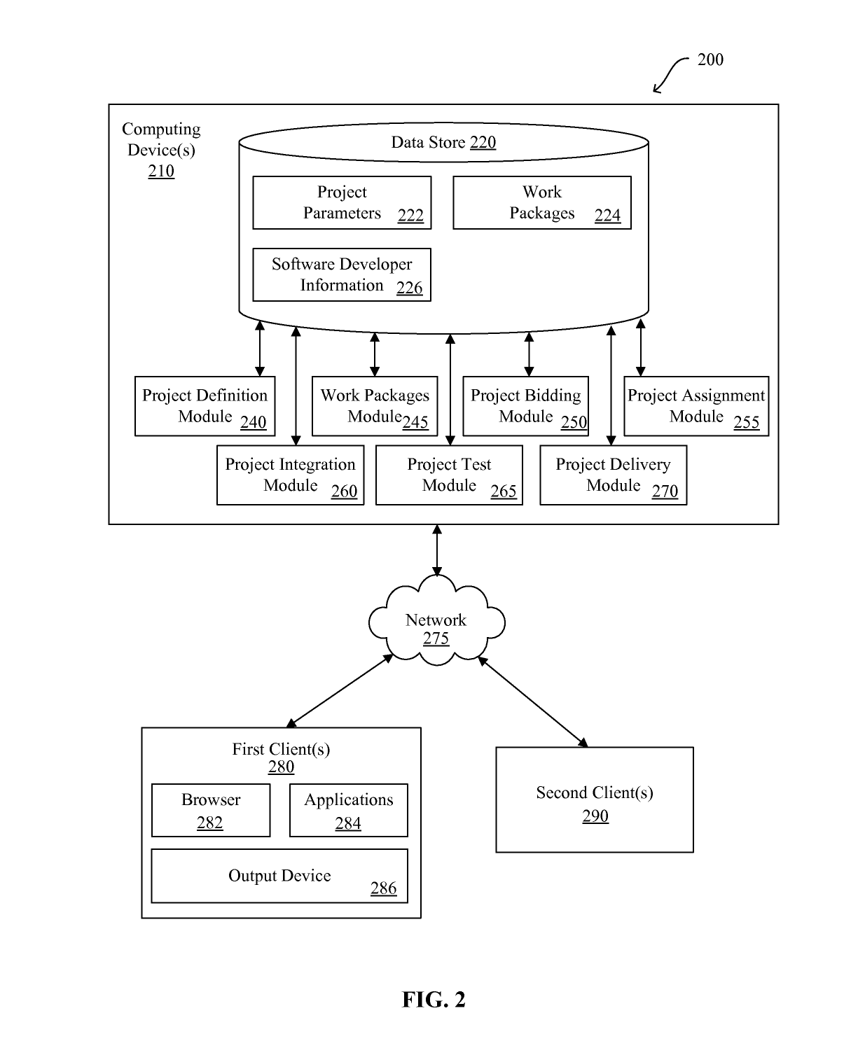

In the following discussion, a general description of an example system for group-oriented software development and the system's components are provided. The general description is followed by a discussion of the operation of the components in a system for the technology. FIG. 2 illustrates a networked environment 200 according to one example of the present technology. The networked environment 200 may include one or more computing devices 210 in data communication with a first client 280 and a second client 290 by way of a network 275. The network 275 may include the Internet, intranets, extranets, wide area networks (WANs), local area networks (LANs), wired networks, wireless networks, or other suitable networks, etc., or any combination of two or more such networks.

Various applications and/or other functionality may be executed in the computing device 210 according to various embodiments. Also, various data may be stored in a data store 220 that is accessible to the computing device 210. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store 220, for example, may be associated with the operation of the various applications and/or functional entities described below.

The data stored in the data store 220 may include project parameters 222. A software development project may be defined by the project parameters 222. The project parameters 222 may be generated based on a marketing requirements document (MRD) and/or a product requirements document (PRD). The MRD and the PRD may be provided by a client and/or produced by an architect that is managing the software development project. In one example, the project parameters 222 may be defined upon receiving a request for software development from the client.

The data stored in the data store 220 may include work packages 224. The work packages 224 may be individual segments of the software development project. For example, the work packages 224 may define segments of computer code that, when created and executed, perform a certain function. In one example, the software development project may be divided into the work packages 224 by the architect involved in the software development project. The work packages 224 may correspond to skill levels that are necessary for completing the work packages 224. The skill levels desired for completing the work packages 224 may range from relatively inexperienced to relatively experienced. The work packages 224 may be associated with proposed bid amounts, i.e., a maximum amount of money that a software developer can bid in order to work on the work package 224. In other words, bids received from software developers that are above the proposed bid amounts may be rejected. Thus, the software developers may place bids to work on the work packages 224, or alternatively, the work packages 224 may be assigned to software developers according to the developers' skill level. In one example, the work packages 224 may be presented to software developers at a listed price, and the software developers may decide whether to work on the work packages 224 for the listed price.

The data stored in the data store 220 may include software developer information 226. The software developer information 226 may include the skill levels associated with a plurality of software developers. The software developer information 226 may include the developers' educational background, qualifications, past work experience, etc. In addition, the software developer information 226 may include the developer's availability to complete upcoming software projects. A list of software projects that the developer is currently working on may be included in the software developer information 226.

The components executed on the computing device 210 may include a project definition module 240, a work packages module 245, a project bidding module 250, a project assignment module 255, a project integration module 260, a project test module 265, a project delivery module 270, and other applications, services, processes, systems, engines, or functionality not discussed in detail herein. The project definition module 240 may be configured to define a software development project with a set of project parameters. The project definition module 240 may define the software development project upon receiving a plurality of project requirements in a software development request from a customer. In other words, the set of project parameters may correspond to the customer's project requirements. In addition, the project definition module 240 may define the software development project according to a marketing requirements document (MRD) and a product requirements document (PRD). In other words, the software development project may be designed to meet various strategies and/or guidelines discussed in the MRD and the PRD.

The work packages module 245 may be configured to divide the software development project into a set of work packages. In one example, the software development project may be divided automatically by a machine based in part on a desired skill level associated with each of the work packages. The work packages module 245 may divide the software development project into more segments in order to simplify and optimize the development of the project. Each work package may correspond to a desired skill level for completing the work package.

The project bidding module 250 may be configured to initiate and facilitate a bidding process involving a plurality of software developers. During the bidding process, a plurality of software developers having the desired skill levels may place bids to work on a certain work package. The bids placed by the software developers may be below or equal to proposed bid amounts associated with the work packages. The proposed bid amounts for the work packages may be previously determined by a machine or the architect. In one example, a software developer may place multiple bids to work on multiple work packages. The project bidding module 250 may receive the bid to complete the work packages from the software developer, determine that the bid was received from the software developer within a proper time frame, verify that the software developer has the desired skill level to complete the work packages, verify that the bid received from the software developer is below or equal to the proposed bid amount or below a previously lowest bid amount, and accept the bid from the software developer when the software developer has a winning bid amount. Alternatively, the project bidding module 250 may reject the bid from the software developer upon determining that the bid was not received within a proper time frame, the software developer does not have the desired skill level to complete the work package, the bid is above the proposed bid amount or the bid is above the previously lowest bid amount.

The project assignment module 255 may be configured to assign each of the work packages to the software developers upon completion of the bidding process. The project assignment module 255 may assign the work package upon determining that the bid was received within the proper time frame and is below or equal to the proposed bid amount (or the bid is the winning bid amount that beat out the other bids). In addition, the project assignment module 255 may assign the work package to a software developer that is qualified to complete the work package. The project assignment module 255 may notify the software developer of the assignment and authorize the software developer to begin work on the work package.

The project integration module 260 may be configured to receive completed work packages from the software developers and integrate the work packages into the software development project. In other words, a plurality of project segments or code segments individually developed by a number of software developers may be recombined into a single unit. The project integration module 260 may verify that the completed work packages are integrated correctly and account for outstanding work packages that have not been received from the software developers.

The project test module 265 may be configured to automatically test the work packages developed by the software developers. The project test module 265 may verify that the work packages function correctly and correspond to the project parameters. The project test module 265 may verify that the work packages function correctly when integrated into the software development project. The project test module 265 may test various inputs associated with work packages for the software development project. In addition, the project test module 265 may test various outputs associated with the software development project.

The project delivery module 270 may be configured to provide a completed software development project according to the set of project parameters to a customer. The project delivery module 270 may bill and/or receive payment from the customer upon delivery of the completed software development project.

Certain processing modules may be discussed in connection with this technology and FIG. 2. In one example configuration, a module of FIG. 2 may be considered a service with one or more processes executing on a server or other computer hardware. Such services may be centrally hosted functionality or a service application that may receive requests and provide output to other services or customer devices. For example, modules providing services may be considered on-demand computing that are hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

The computing device 210 may comprise, for example, a server computer or any other system providing computing capability. Alternatively, a plurality of computing devices 210 may be employed that are arranged, for example, in one or more server banks, computer banks or other computing arrangements. For example, a plurality of computing devices 210 together may comprise a clustered computing resource, virtualization server, a grid computing resource, and/or any other distributed computing arrangement. Such computing devices 210 may be located in a single installation or may be distributed among many different geographical locations. For purposes of convenience, the computing device 210 is referred to herein in the singular. Even though the computing device 210 is referred to in the singular, it is understood that a plurality of computing devices 210 may be employed in the various arrangements as described above.

The first client 280 and the second client 290 are representative of a plurality of client devices that may be coupled to the network 275. The first client 280 and the second client 290 may comprise, for example, a processor-based system such as a computer system. Such a computer system may be embodied in the form of a desktop computer, a laptop computer, personal digital assistants, cellular telephones, smartphones, set-top boxes, network-enabled televisions, music players, tablet computer systems, game consoles, electronic book readers, or other devices with like capability.

The first client 280 may be configured to execute various applications such as a browser 282, and/or other applications 284. The applications 284 may correspond to code that is executed in the browser 282 (e.g., web applications). The applications 284 may also correspond to standalone applications, such as networked applications. In addition, the client 280 may be configured to execute applications 284 that include, but are not limited to, video playback applications, standalone applications, email applications, instant message applications, and/or other applications. In addition, the second client 290 may also include a browser and/or applications (not shown in FIG. 2).

The first client 280 may include or be coupled to an output device 286. The browser 282 may be executed on the first client 280, for example, to access and render network pages (e.g. web pages) or other network content served up by the computing device 210 and/or other servers. The output device 286 may comprise, for example, one or more devices such as cathode ray tubes (CRTs), liquid crystal display (LCD) screens, gas plasma-based flat panel displays, LCD projectors, or other types of display devices, etc. In addition, the output device 286 may include an audio device, tactile device (e.g., braille machine) or another output device to feedback to a user. In addition, the second client 290 may also include an output device (not shown in FIG. 2).

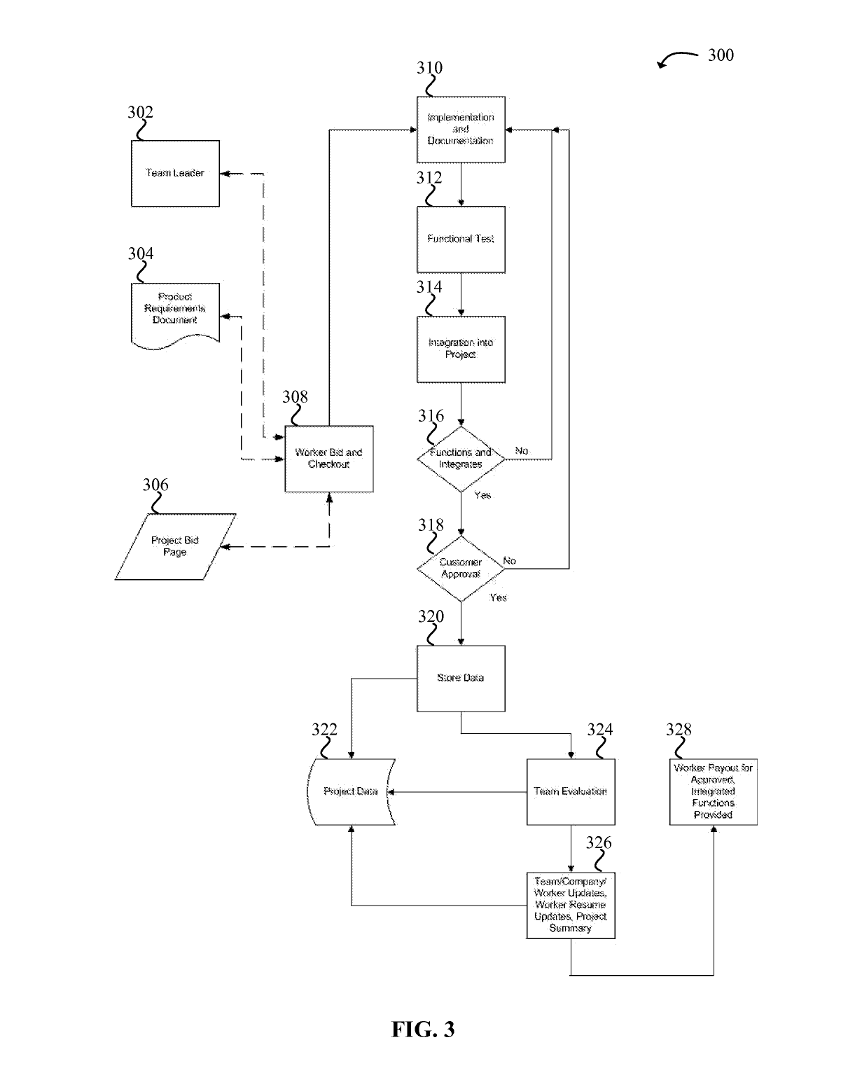

FIG. 3 is a flow chart 300 illustrating an example project work flow. A team leader 302 may manage a software development project and insure that the distributed work packages are progressing according to schedule. The team leader role also manages the potential risk that freelancer developers fail to deliver assigned work product according to the defined schedule. Based on the complexity, size and criticality of the work package, risk mitigation of the work package completion risk may be put into place. Mitigation decisions may be coordinated between the team leader 302 and a system architect.

A product requirements document (PRD) 304 may include a plurality of project parameters and customer requirements for the software development project. The team leader 302 and/or the architect may design the software development project in accordance with the PRD 304. The team leader 302 and/or the architect can divide the software development project into a plurality of work packages. A project bid page 306 may be created. The project bid page 306 may outline the plurality of work packages that can be bid on and/or completed by the software developers. During the worker bid and checkout phase 308, the software developers may bid on or check out certain work packages. For example, the software developers may desire to work on work packages that correspond to their skill level.

The plurality of work packages may be completed during an implementation and documentation phase 310. A functional test 312 may verify that the work packages are functioning correctly. The work packages may be integrated back into the software development project, as in block 314. The software development project may be tested to verify that the work packages function correctly when integrated together, as in block 316. The software development project may be provided for customer approval 318 and stored 320 in a data store. In other words, the software development project may be stored as project data 322. The project data 322 may include a team evaluation 324, i.e., an evaluation of the plurality of software developers, the architect, and the team leader with respect to the project. The project data 322 may include worker updates and a project summary 326. The project summary 326 may include a cost to complete the project, whether the project requirements were met, an amount of time to complete the project, etc. The software developers, the architect and the team leader may be compensated upon verifying that the work packages in the software development project function correctly, as in block 328, and according to the PRD.

Some companies may be trying to find ways that the creativity and technical skills of the crowd may be harnessed. There are many examples of crowd focused development work transitioning to the enterprise marketplace. Some companies may sponsor challenges that leverage open innovation techniques and the promise of financial rewards and recognition to individuals or teams that are able to solve an enterprise problem. Some companies may publish application programming interfaces (APIs) back to their core functionality so that actors outside of traditional firm boundaries can be engaged in software development. This model may enable structured management and reporting of freelance resources that allows companies to better leverage the investments that are being made in the applications being developed.

In some scenarios open innovation may be very powerful, as the participants tend to have at least some context of the situation that a firm is trying to address. For example, someone developing an application for use on a smartphone that is wirelessly connecting to a vehicle has frequently had a chance to be a driver before, and as such has a relatively high degree of context of how the capability under development would or could be used. This situational context can allow the developer a high level of understanding of the business problem, thereby enabling them to deliver valuable functionality. This context on the part of developers can allow APIs that are designed to provide consumer facing capabilities to be a catalyst for innovative delivery outside of traditional development channels.

While developers in an open innovation environment may have some situational context to support development efforts, external players may not have the same level of context in other enterprise software delivery environments. In the case of open innovation challenges, participating companies may provide context to specific requirements of the parameters of the contest, such contests may not be scalable to suit larger development needs. Using the contest model of freelance crowdsourcing, nearly all of the developed code may be discarded, and most of the contest participants may receive no remuneration for their time. The concept of open innovation contests may be promising in certain circumstances, but there seems to be too much wasted effort on the part of participants for innovation contests to be scalable over large development projects.

This model may provide a platform and business process through which the context regarding the nature of the technical problems faced by the client can be understood and addressed by the team leaders and architects and the freelance developers may need to know less about overall context. The work of the service providers' architects in decomposing complex deliverables into 10-30 hour work packages may reduce the requirement for developers to have contextual knowledge and may allow for greatly increased participation in the freelancing environment.

Without explicit direction regarding enterprise needs, there may be little chance that freelance developers would be able to come up with specific functionality that would meet an enterprise need. A crowd sourced broker would have to be in place to translate the enterprise requirements into actionable work package pieces that could then be developed by certified freelance providers. If a firm has developed internal standards, has development protocols in place, and has an infrastructure architecture it may leverage, the technology to leverage crowdsourcing methods may be used to develop software. The group-oriented software development method can also provide services that allow clients to prepare for and utilize crowd sourced software development in order to provide enterprise software.

In order to leverage freelance, crowd sourced resources, a firm may need to identify the coding, design and interface standards within the firm's technical environment. The degree and nature of the standards are typically firm specific. Some firms may choose to have minimal standards, and others may be more regimented. This model may consolidate and streamlines the process, standards. governance and distribution. Standards defined within the system may be documented in a searchable format that freelancers can reference during the development process. If a freelancer fails to follow the prescribed software development standards of the firm, the code developed will not be accepted upon completion. Prior to engaging in the radical agile approach to software development, a firm can develop a software development kit (SDK) encompassing the technical platforms and programming languages that freelancers would be developing with.

In order for the distributed pieces of development work defined in the model to come together seamlessly, clear understanding and documentation of the interface requirements are needed. A clearly defined enterprise service bus, or service registry may be one mechanism for interface definition, or clearly defined application programming interfaces (APIs) may also be used. Coordinating the development of multiple participants in a large project is a challenge, whether those developers are internal hires, outsource providers or freelancers. The significant costs of integration process maturity, extensive testing regimes and management oversight are examples of the cost of doing development without adequately defined interface architecture. One of the underlying principles of this technology, is that the large amount dollars that may otherwise be spent on management and oversight can be exchanged for a smaller amount of dollars spent on standards and architecture. This exchange can create a cost savings, and it also can provide flexibility, reuse and quality that cannot be achieved through disciplinary oversight.

A valuable role in decomposing a large, complex development project into manageable individual pieces is the role of the System Architect. This role is used to understand the interplay of the firm specific software development kit (SDK) and APIs on the development project, as well as the specific technical skills and the skill levels of freelance developers who may participate in the project. This role is a valuable aspect of the delivery process. For example, the System Architect generally scopes the project, breaks it into work packages, designs the algorithms, and assigns tasks based on the abilities of the available engineers. Alternatively, the development project may be decomposed into individual pieces by a machine.

Team leaders and/or the present software technology may manage the overall delivery and timelines of a project. The team leaders and/or the software technology may insure that the delivery of work from the freelance developers participating in the project is occurring in a timely manner. In addition, the team leader and/or software technology may also be responsible for compiling and delivering the project status reports to the customers, architects and customer relationship management teams as appropriate.

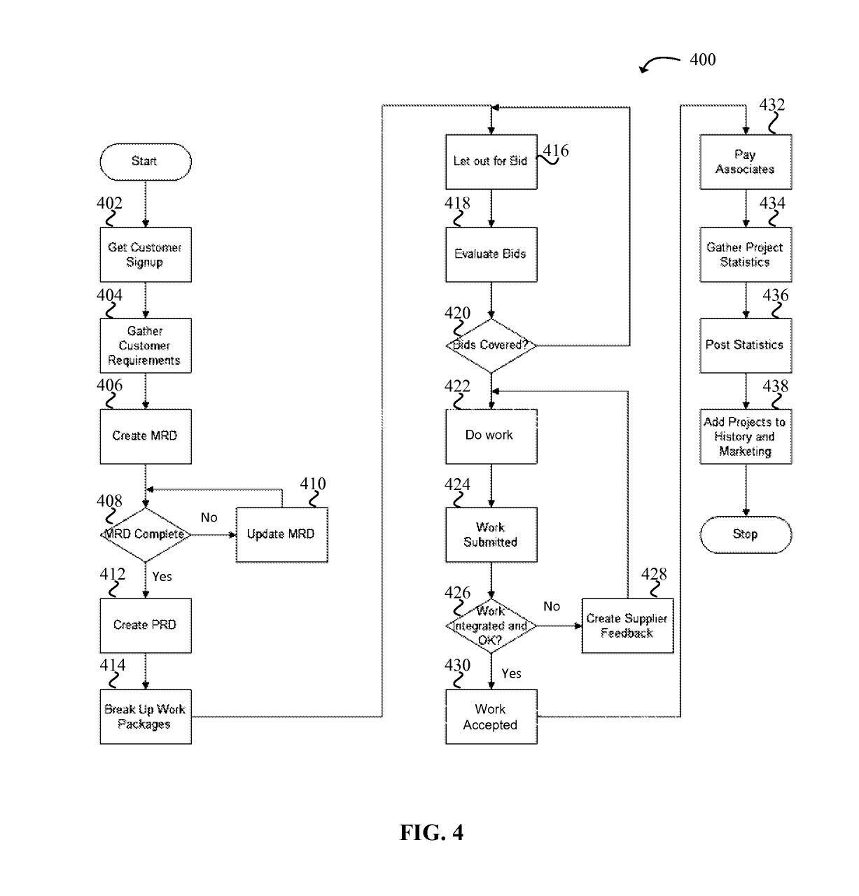

FIG. 4 is a flowchart 400 illustrating an exemplary project work flow. In step 402, a customer desiring development of a software project may sign up to receive software development services. In step 404, customer requirements for the software project may be gathered. In step 406, a marketing requirements document (MRD) may be created. The MRD may be created with help from a marketing team. The MRD may include various marketing parameters based on marketing research performed by the marketing team. For example, the MRD may include a marketing assessment and target demographics. The MRD may include a purpose for the project from both a technical and business perspective. In step 408, whether the MRD is complete may be determined. In step 410, if the MRD is not complete, the MRD may be updated with additional marketing parameters.

In step 412, a product requirements document (PRD) may be created. The PRD may include various product parameters, such as design specifications, functional requirements, usability requirements, technical requirements, assumptions and constraints. The PRD may include workflow plans, timelines, milestones, evaluation plans and performance metrics.

In step 414, the software project may be broken up into a plurality of work packages. The work packages may include individual pieces of code or functionality that are to be implemented by software developers. In step 416, a plurality of bids may be received from the software developers that wish to build the work packages. In step 418, the bids from the software developers may be evaluated. For example, the skill levels associated with the software developers may be evaluated when determining whether to select a particular software developer to work on a work package. In step 420, the software developers may be notified of their winning bids. In step 422, the software developers may begin work on the work packages. In one example, a single software developer may work on multiple work packages. Alternatively, a group of software developers may work on a single work package.

In step 424, the software developers may submit completed work packages. In step 426, the work packages may be integrated and then tested to verify that the work packages function correctly after the integration. In step 428, feedback may be provided and the work packages may be further revised and then reintegrated. The software project containing the work packages may be provided to the customer. In step 430, the customer may accept the software project. In step 432, the software developers that completed the work packages may be compensated. In one example, the software developers may be compensated contingent on the work packages functioning correctly. In step 434, project statistics may be gathered and then, in step 436, the project statistics may be posted such that the software developers, the architect and the team leader may view the project statistics. In step 438, the software project may be added to a history and marketing strategies for the software project may be developed.

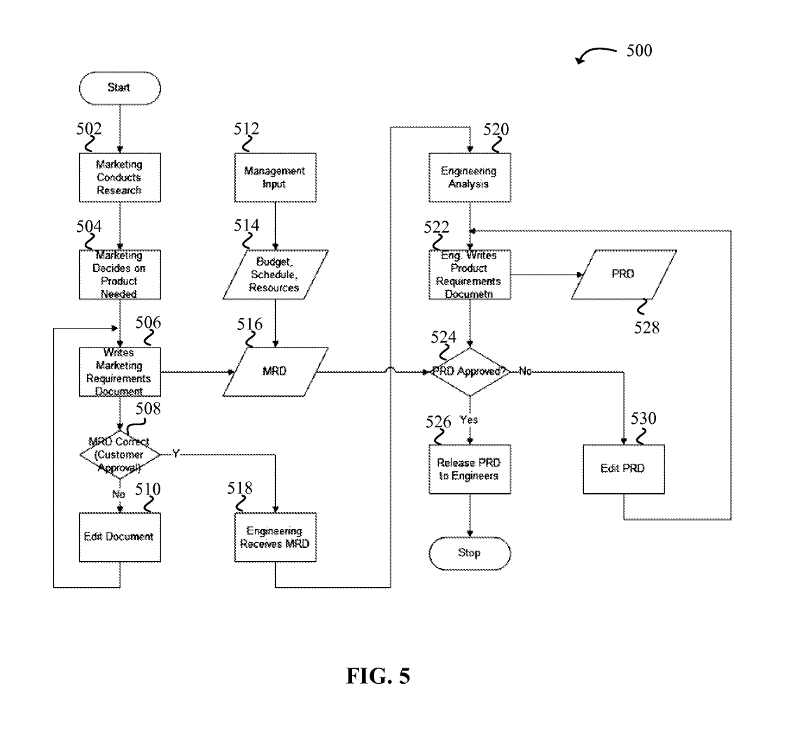

FIG. 5 is a flowchart 500 illustrating an exemplary project work flow using marketing research and engineering analysis. In step 502, a marketing team may conduct research, and in step 504, the marketing team may identify a desired product. In step 506, a marketing requirements document (MRD) 516 may be written for the product. The MRD 516 may consider management input 512, as well as budgets, schedules and resources 514.

In step 508, the MRD 516 may be provided to a customer. The customer may approve the MRD 516 for the product. In step 510, the MRD 516 may be edited if the customer offers suggestions for improving the MRD 516. In step 518, the MRD 516 may be provided to an engineering team. In step 520, the engineering team may examine the desired product and the MRD 516. In step 522, the engineering team may write a product requirements document (PRD) 528. In step 524, the PRD 528 may be approved and then, in step 526, the PRD 528 may be released to the engineering team to commence development of the product. In step 530, the PRD 528 may be revised based on feedback and then released to the engineering team.

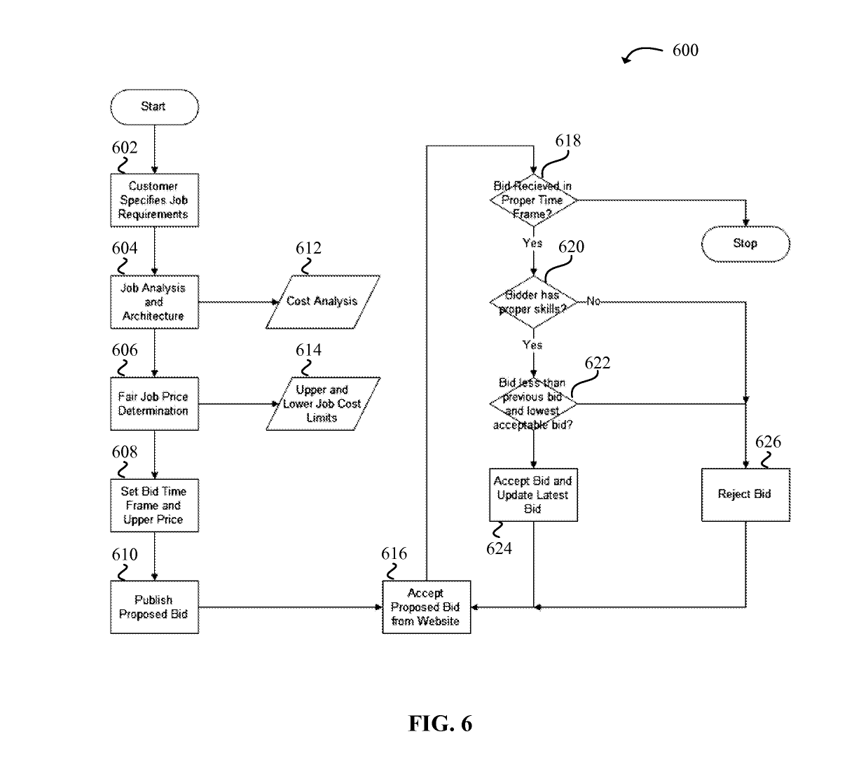

FIG. 6 is a flowchart 600 illustrating an exemplary reverse bidding auction. In step 602, a customer may specify various requirements and parameters for a software development project. In step 604, an analysis of the software development project may be conducted. For example, a cost analysis for completing the project may be performed in step 612. In step 606, a fair price for completing the software development project may be determined. For example, upper and lower cost limits may be determined in step 614.

In step 608, a bid time frame and an upper price for a bid (e.g., a proposed bid) may be set. As a non-limiting example, bids may be accepted for a period of two weeks and the upper price for the proposed bid for a work package may be $5000. In step 610, the proposed bid may be published on an electronic page, such that a plurality of software developers may view the proposed bid. In addition, a brief description of the software development project and desired skill levels may be included in the publication.

In step 616, a software developer may accept the proposed bid from the electronic page. In step 618, whether the bill was received in the proper time frame may be verified. In step 620, whether the bidder (i.e., the software developer that placed the bid) has the proper skills may be verified. In step 622, whether the bid is the lowest acceptable bid may be determined. In step 624, if the bid was received in the proper time frame, the bidder has the proper skills, and the bid is the lowest acceptable bid, then the software developer's bid may be accepted. In step 626, the bid may be rejected if the bid was not received in the proper time frame, the bidder does not have the proper skills, or the bid is greater than the lowest acceptable bid.

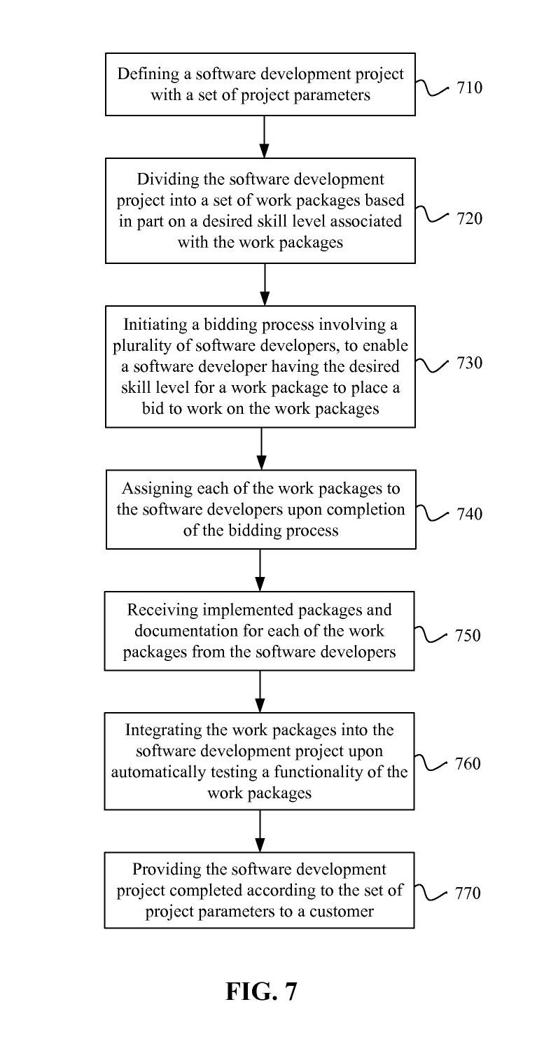

FIG. 7 illustrates an example of a method for group-oriented software development. A software development project may be defined with a set of project parameters, as in block 710. The software development project may be defined in response to receiving a software development request from a customer. In addition, the software development project may be defined according to a marketing requirements document (MRD) and a product requirements document (PRD).

The software development project may be divided into a set of work packages based in part on a desired skill level associated with the work packages, as in block 720. The work packages may be designed to correspond to a variety of desired skill levels. The desired skill levels may be associated with the software developers that are completing the work packages. For example, the desired skill level for each of the work packages may range from inexperienced (e.g., 0 on a scale from 0 to 10) to experienced (e.g., 10 on a scale from 0 to 10). In other words, an experienced software developer may be able to complete work packages having the desired skill level of experienced.

A bidding process may be initiated involving a plurality of software developers, as in block 730. A software developer having the desired skill level for a work package may place a bid to work on the work package. In one example, the software developer may learn of the availability of the work package via a publication on an electronic page. A proposed bid amount may be published for each of the work packages, along with a description and a desired skill level for each of the work packages. The proposed bid amount may be a maximum amount of money that a software developer can bid in order to work on the work package. The software developer may submit a bid that is below or equal to the proposed bid amount during the bidding process. In addition, the software developer may submit a bid that is below a previously lowest bid amount (e.g., a bid previously placed by another software developer. The proposed bid amount for each of the work packages included in the software development project may be calculated based on a cost and other requisites associated with building the software development project.

Each of the work packages may be assigned to the software developers upon completion of the bidding process, as in block 740. The bid to work on the work package may be received from the software developer. The bid may be determined to have been received from the software developer within a proper time frame. The software developer may be verified to possess a desired skill level to work on the work package. The bid received from the software developer may be verified as being below or equal to the proposed bid amount. In addition, the bid received from the software developer may be verified to be below the previously lowest bid amount. Thereafter, the bid from the software developer may be accepted when the software developer has a winning bid amount. Alternatively, the bid from the software developer may be rejected upon determining that the bid was not received within a proper time frame, the software developer does not have the desired skill level to work on the work package, or the bid is above a proposed bid amount.

Implemented packages and documentation for each of the work packages may be received from the software developers, as in block 750. The functionality of the implemented packages and documentation may be tested for each of the work packages. In other words, the work performed by the software developers may be reviewed and corrected if needed.

The work packages may be integrated into the software development project upon automatically testing a functionality of the work packages, as in block 760. In other words, a plurality of project segments or code segments individually developed by a number of software developers may be recombined into a single unit. The automated test and integration results may be provided to the customer for approval.

A software development project completed according to the set of project parameters may be provided to a customer, as in block 770. The customer may verify that the completed software development project meets the customer's requirements, as well as the MRD and the PRD. The customer may provide a payment upon receiving the completed software development project.

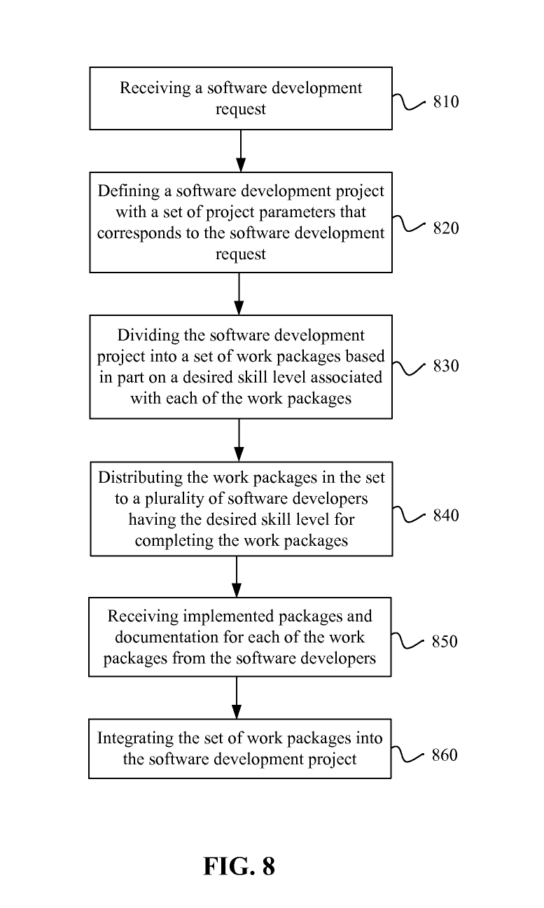

FIG. 8 illustrates another example of a method for group-oriented software development. A software development request may be received, as in block 810. The software development request may be received by a customer or a potential customer.

A software development project with a set of project parameters may be defined that corresponds to the software development request, as in block 820. The software development project may be defined according to a marketing requirements document (MRD) and a product requirements document (PRD).

The software development project may be divided into a set of work packages based in part on a desired skill level associated with each of the work packages, as in block 830. The software development project may be divided into more manageable software chunks to streamline the development of the project.

The work packages in the set may be distributed to a plurality of software developers having the desired skill level for completing the work packages, as in block 840. In one example, a software developer may check out a work package upon showing that the software developer possesses the desired skill level for completing the work package. A database may be maintained that contains information about the plurality of software developers. The database may include a skill level associated with each software developer and a current availability for completing the work packages.

In one example, the work package may be presented to the software developer having a listed price. The listed price may identify an amount of compensation to be provided to the software developer upon completion of the work package. The software developer may review the work package and the listed price and determine whether to claim or accept the work package. In other words, the software developer can decide whether the listed price is acceptable, and if so, begin work on the work package upon claiming the work package.

Implemented packages and documentation for each of the work packages may be received from the software developers, as in block 850. The functionality for each of the work packages that are completed according to the set of project parameters may be verified. The software developers may be compensated for completing work packages which function correctly and correspond to the set of project parameters.

The set of work packages may be integrated into the software development project, as in block 860. In other words, the work packages (e.g., segments of computer code) may be combined in order to operate with each other. The software development project may comprise of the plurality of computer code segments.

In one example, a plan for completion of the software development project may be provided to the customer via a user interface. The work packages in the software development project may be assigned to the plurality of software developers upon receiving approval of the plan from the customer. The plurality of software developers may be authorized to collaborate in teams when completing the work packages. A contractual relationship may be arranged with the plurality of software developers, a software manager, or a plurality of software project clients. Performance metrics on progress of the software development project may be tracked. Milestones for the software development project may be verified as being met substantially on time.

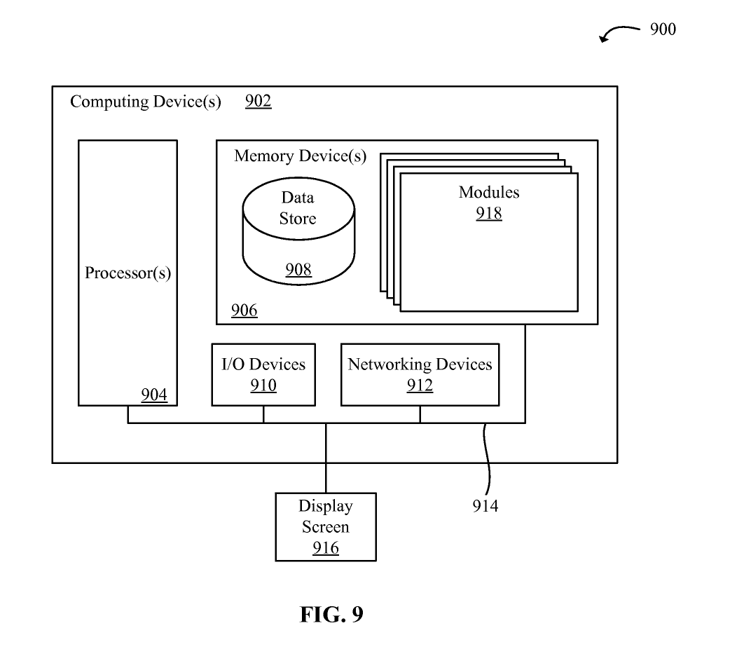

FIG. 9 is block diagram 900 illustrating an example of a computing device 902 that may be used in group-oriented software development. In particular, the computing device 902 can illustrate a high level example of a device on which modules of the disclosed technology may be executed. The computing device 902 may include one or more processors 904 that are in communication with memory devices 906. The computing device 902 may include a local communication interface 914 for the components in the computing device. For example, the local communication interface may be a local data bus and/or any related address or control busses as may be desired.

The memory device 906 may contain modules 918 that are executable by the processor(s) 904 and data for the modules. Located in the memory device 906 are modules executable by the processor. The modules may execute the functions described earlier. A data store 908 may also be located in the memory device 906 for storing data related to the modules and other applications along with an operating system that is executable by the processor(s) 904.

Other applications may also be stored in the memory device 906 and may be executable by the processor(s) 904. Components or modules discussed in this description that may be implemented in the form of software using high programming level languages that are compiled, interpreted or executed using a hybrid of the methods.

The computing device may also have access to I/O (input/output) devices 910 that are usable by the computing devices. An example of an I/O device is a display screen 916 that is available to display output from the computing devices. Other known I/O devices may be used with the computing device as desired. Networking devices 912 and similar communication devices may be included in the computing device. The networking devices 912 may be wired or wireless networking devices that connect to the internet, a LAN, WAN, or other computing network.

The components or modules that are shown as being stored in the memory device 906 may be executed by the processor(s) 904. The term “executable” may mean a program file that is in a form that may be executed by a processor 904. For example, a program in a higher level language may be compiled into machine code in a format that may be loaded into a random access portion of the memory device 906 and executed by the processor 904, or source code may be loaded by another executable program and interpreted to generate instructions in a random access portion of the memory to be executed by a processor. The executable program may be stored in any portion or component of the memory device 906. For example, the memory device 906 may be random access memory (RAM), read only memory (ROM), flash memory, a solid state drive, memory card, a hard drive, optical disk, floppy disk, magnetic tape, or any other memory components.

The processor 904 may represent multiple processors and the memory device 906 may represent multiple memory units that operate in parallel to the processing circuits. This may provide parallel processing channels for the processes and data in the system. The local interface 914 may be used as a network to facilitate communication between any of the multiple processors and multiple memories. The local interface 914 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology. Additionally, computer readable storage media may be located in one or more remote locations (e.g. cloud storage).

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method for group-oriented software development, the method comprising:
under control of one or more computer systems configured with executable instructions:
defining a software development project with a set of project parameters;
dividing the software development project into a set of work packages based in part on a desired skill level associated with the work packages;
initiating a bidding process involving a plurality of software developers to enable a software developer having the desired skill level for a work package to place a bid to work on the work packages;
assigning each of the work packages to the software developers upon completion of the bidding process;
receiving implemented packages and documentation for each of the work packages from the software developers;
integrating the work packages into the software development project upon automatically testing a functionality of the work packages; and
providing the software development project completed according to the set of project parameters to a customer.

2. The method of claim 1, further comprising calculating a proposed bid amount for each of the work packages included in the software development project based in part on a cost and other requisites associated with building the software development project.

3. The method of claim 1, further comprising publishing a proposed bid amount for each of the work packages, along with a description of each of the work packages and a desired skill level for each of the work packages.

4. The method of claim 1, further comprising:
receiving the bid to work on the work package from the software developer;
determining that the bid was received from the software developer within a proper time frame;
verifying that the software developer has a desired skill level to work on the work package;
verifying that the bid received from the software developer is below or equal to a proposed bid amount; and
accepting the bid from the software developer when the software developer has a winning bid amount.

5. The method of claim 1, further comprising rejecting the bid from the software developer upon determining at least one of: the bid was not received within a proper time frame, the software developer does not have the desired skill level to work on the work package, or the bid is above a proposed bid amount.

6. The method of claim 1, further comprising defining the software development project in response to receiving a software development request from the customer.

7. The method of claim 1, further comprising:
testing a functionality of the implemented packages and documentation for each of the work packages; and
providing test and integration results to the customer for approval.

8. The method of claim 1, further comprising designing the work packages to correspond to a variety of skill levels.

9. The method of claim 1, further comprising defining the software development project according to a marketing requirements document (MRD) and a product requirements document (PRD).

10. A method for group-oriented software development, the method comprising:
under control of one or more computer systems configured with executable instructions:
receiving a software development request;
defining a software development project with a set of project parameters that corresponds to the software development request;
dividing the software development project into a set of work packages based in part on a desired skill level associated with each of the work packages;
distributing the work packages in the set to a plurality of software developers having the desired skill level for completing the work packages;
receiving implemented packages and documentation for each of the work packages from the software developers; and
integrating the set of work packages into the software development project.

11. The method of claim 10, further comprising:
verifying a functionality for each of the work packages that are completed according to the set of project parameters; and
compensating the software developers for completing work packages which function correctly and correspond to the set of project parameters.

12. The method of claim 10, further comprising arranging a contractual relationship with at least one of: the plurality of software developers, a software manager or a plurality of software project clients.

13. The method of claim 10, further comprising authorizing the plurality of software developers to collaborate in teams when completing the work packages.

14. The method of claim 10, further comprising:
tracking performance metrics on progress of the software development project; and
verifying that milestones for the software development project are being met substantially on time.

15. The method of claim 10, further comprising:
defining the software development project with the set of project parameters according to a marketing requirements document (MRD) and a product requirements document (PRD);
providing a plan for completion of the software development project to a customer via a user interface; and
assigning the work packages in the software development project to the plurality of software developers upon receiving approval of the plan from the customer.

16. The method of claim 10, further comprising maintaining a database of the plurality of software developers, the database including a skill level associated with each software developer and a current availability for completing the work packages.

17. A system for group-oriented software development, the system comprising:
a processor;
a memory device including a data store to store a plurality of data and instructions that, when executed by the processor, cause the processor to execute:
a project definition module configured to define a software development project with a set of project parameters;
a work packages module configured to divide the software development project into a set of work packages based in part on a desired skill level associated with each of the work packages;
a project bidding module configured to initiate a bidding process involving a plurality of software developers and to enable a software developer having the desired skill level for a work package places a bid to work on the work package;
a project assignment module configured to assign each of the work packages to the software developers upon completion of the bidding process;
a project integration module configured to receive completed work packages from the software developers and integrate the work packages into the software development project; and
a project delivery module configured to provide the software development project completed according to the set of project parameters to a customer.

18. The system of claim 17, wherein the project bidding module is further configured to:
receive the bid to complete the work packages from the software developer;
determine that the bid was received from the software developer within a proper time frame;
verify that the software developer has the desired skill level to complete the work packages;
verify that the bid received from the software developer is below or equal to a proposed bid amount; and
accept the bid from the software developer.

19. The system of claim 17, further comprising a project test module configured to test at least one of: the work packages, inputs associated with the software development project, or outputs associated with the software development project.

20. The system of claim 17, wherein the project definition module is further configured to:
define the software development project in response to receiving a software development request from the customer; and
define the software development project according to a marketing requirements document (MRD) and a product requirements document (PRD).
